(19) United States
(12) Patent Application Publication
(10) Pub. No.: US 2020/0130810 A1
(43) Pub. Date: Apr. 30, 2020

(54) AERIAL VEHICLE TETHER

(71) Applicant: Astigan Limited, Southampton Hampshire (GB)

(72) Inventor: Andrew Charles ELSON, Southampton Hampshire (GB)

(21) Appl. No.: 16/624,629

(22) PCT Filed: Jun. 20, 2018
(86) PCT No.: PCT/GB2018/051721

§ 371 Date: Dec. 19, 2019

(30) Foreign Application Priority Data
Jun. 21, 2017 (GB) 1709886.4

(51) Int. Cl. B64C 7/00; B64C 3/18; B64C 39/02; B64C 9/02; B64D 9/00; B64F 5/10

(52) U.S. Cl. CPC B64C 7/00; B64C 3/185; B64C 39/024; B64C 9/02; B64C 2201/108; B64F 5/10; B64C 2201/021; B64C 2201/042; B64D 9/00

(57) ABSTRACT

An aerial vehicle has a wing and a fuselage. A tether is anchored at opposing ends of the wing and/or the fuselage. The tether is arranged to prevent one or more parts of the aerial vehicle from separating from the remainder of the aerial vehicle in the event of structural failure of the aerial vehicle.

### FIELD OF THE INVENTION

The present invention relates to an aerial vehicle and a method of assembling an aerial vehicle.

### BACKGROUND OF THE INVENTION

The design of aerial vehicles is generally optimised according to the intended application or missions to be undertaken and the anticipated environmental conditions. In the case of aerial vehicles, and particularly unmanned aerial vehicles (UAVs), operating at high altitude, e.g. in the stratosphere, for extreme duration flights lasting weeks or months, the design requires close attention to a number of critical factors. Among these, minimising the weight of the vehicle and its payload in order to keep the power requirement to a minimum must be balanced with the structural strength of the vehicle and its ability to withstand loads encountered at various stages of flight.

Flight at stratospheric altitudes has the advantage that the stratosphere exhibits very stable atmospheric conditions, with wind strengths and turbulence levels at a minimum between altitudes of approximately 18 to 30 kilometres. This allows the external load bearing requirements of the aircraft structure in flight to be minimised, and is preferable for a variety of missions such as mapping and surveillance. Optimising the aircraft structure for operations in the stratosphere poses challenges for the recovery of the aircraft to ground level where external load bearing requirements may be higher.

### SUMMARY OF THE INVENTION

A first aspect of the invention provides an aerial vehicle comprising a wing, a fuselage and at least one tether anchored at opposing ends of the wing and/or the fuselage, wherein the at least one tether is arranged to prevent one or more parts of the aerial vehicle from separating from the remainder of the aerial vehicle in the event of structural failure of the aerial vehicle.

A second aspect of the invention provides a method of assembling an aerial vehicle comprising a wing and a fuselage, the method comprising providing at least one tether; and anchoring the tether at opposing ends of the wing and/or the fuselage, wherein the at least one tether is arranged to prevent one or more parts of the aerial vehicle from separating from the remainder of the aerial vehicle in the event of structural failure of the aerial vehicle.

Whilst every effort may be made to ensure the structural integrity of the aerial vehicle during intended operating conditions, if such a vehicle is especially lightweight and fragile, e.g. optimised for flight at high altitude, then factors such as an unexpected change in weather condition at lower altitude could present operating conditions outside of the intended operating conditions which may exceed the limits at which structural integrity of the aircraft can be ensured. However it remains important to be able to recover the aerial vehicle to the ground without incident.

The at least one tether anchored at opposing ends of the wing and/or the fuselage is arranged to prevent one or more parts of the aerial vehicle from separating from the remainder of the aerial vehicle in the event of structural failure of the aerial vehicle. Any parts of the aerial vehicle having significant mass may be connected to the tether(s) such that the aerial vehicle can continue to descend without any parts of significant mass breaking away and descending to the ground alone.

Alternatively, the aerial vehicle may be design to fail (actively or passively) under particular operating conditions in a controlled manner, rather than by an uncontrolled structural failure. For example, at least a part of the wing may be released from the remainder of the vehicle and is retained by the tether. This controlled structural failure may cause the aerial vehicle to adopt a configuration in which the aerial vehicle enters a downward spiral, slowing the descent of the aerial vehicle to a partially controlled crash landing.

The one or more tethers may secure the wing and the fuselage from separating from the aerial vehicle in case of structural failure. The wing and the fuselage can be connected through the one or more of the tethers and in case of structural failure between the wing and the fuselage, the wing and the fuselage can be retained together.

The aerial vehicle may include a plurality of the tethers. One of the tethers can be arranged to loop around another tethers so as to couple the tethers. For example, one tether passing through or along the fuselage may form a loop around another tether passing through or along the wing. This can ensure that the wing and the fuselage are securely connected and separation between the wing and the fuselage in case of structural failure can be prevented. Each of the wing or fuselage may have a plurality of tethers arranged in series, with the endmost tethers anchored to opposing ends of the wing or fuselage.

The wing and/or the fuselage can comprise one or more tubular structures. The at least one tether can pass through the tubular structure(s). The tether can be anchored at opposing ends of the tubular structure.

One tether can pass through the tubular structure of the wing and another tether can pass through the tubular structure of the fuselage. In case the aerial vehicle has more than one fuselage, one or more tethers can pass though the fuselages; either one tether per fuselage or multiple tethers per fuselage, or one tether through multiple fuselages joined e.g. through the wing.

A benefit of an aerial vehicle having at least one tubular structure as part of the fuselage and/or the wing with one or more tethers which pass through such tubular structure is that any structural failure at an intermediary part of the wing and/or fuselage that may occur does not cause separation or break up of the vehicle. The parts of the vehicle on either side of the structural failure may be retained by the tether, which is constrained by the tubular structure through which it passes. There is no requirement for any intermediary anchoring attachments, since any structural failure in an intermediary part of the tubular structure is retained by the tether anchored at the opposing ends of the structure. Therefore the tubular structure can restrain the tether close to the location of the structural failure.

The tubular structure may include at least one aperture configured to permit the tether to enter or exit the tubular structure.

One or more apertures can be formed on at least one of the fuselage tubular structure and the wing tubular structure. For example, a tether in the fuselage tubular structure may exits and loop around, i.e. fully encircle, the wing tubular structure before re-entering the fuselage tubular structure, or vice versa for a tether in the wing tubular structure around the fuselage tubular structure. Where both the wing and fuselage tubular structures have a respective tether inside, the tethers become coupled together by the looping of one tether about another tether.

Such an arrangement enables each tether to be connected to another tether. Therefore any structural failure at the aerial vehicle parts between the two tethers can be retained due to the loop formed between the tethers.

The wing and/or fuselage can comprise at least one elongate structure and the at least one tether can be secured to the elongate structure at one or more intermediary locations between the opposing ends of the wing and/or the fuselage.

One or more tethers can be anchored along intermediary locations of the elongate structure. The tethers can be anchored along intermediary locations along a surface of the elongate structure. The elongate structure may comprise a channel to accommodate the tether and one or more intermediary attachments to anchor the tether at one or more intermediary locations between the opposing ends of the elongate structure. The elongate structure can comprise a beam.

In case a structural failure occurs, the intermediary attachments can constrain movement of the tether away from the elongate structure between the anchored ends of the tether.

The one or more tethers may have a higher tensile strength than the wing and/or the fuselage. The tether may have sufficient tensile strength to failure greater than any loads expected to be experienced by the aerial vehicle. By contrast, the wing and/or fuselage may be structurally optimised for normal flight operating conditions.

The tether may be a cord, rope, wire, line, lanyard, or other suitable component. The tether may be can comprise braided strands. Interlacing two or more strands creates a structure that is thicker and stronger than non-braided strands.

The tether can comprise fibres, e.g. fibre reinforced polymer. Fibre reinforced polymer can provide directional strength and stiffness. The one or more tethers can comprise aramid or Kevlar™ fibres and/or carbon fibres and/or polymer resin. Composite materials can provide high strength-to-weight ratio and enable weight savings for the aerial vehicle. The tether can comprise silk fibres, metal, nylon or other suitable materials.

In particular, the tether may include ultra-high-molecular-weight polyethylene such as Dyneema™ or Spectra™ fibre material.

The vehicle may further comprise at least one component of significant mass as a proportion of the aerial vehicle as a whole, and the at least one tether can be anchored to the at least one component of significant mass. Examples of such high mass parts include a flight control surface, a payload, a main battery or batteries, a motor, a propeller, etc.

The flight control surface may include a tailplane surface, a rudder, an elevator, a ruddervator, etc.

Payload may be defined as that portion of the mass of the aircraft that is not primarily used for propulsion and control of the aircraft. Payload may include data acquisition, storage and transmission equipment, and associated power supplies such as batteries, for example.

In case of a structural failure between a high mass part and the remainder of the aerial vehicle and the remainder of the vehicle, the part may remain connected to the aerial vehicle through the tether.

The tether can be anchored by passing the tether around one or more of: a pin, a hook, a loop or other suitable anchoring point. The pin may be a releasable pin to aid anchoring of the tether. A tether may extend away from one anchoring point and return to the same anchoring point.

One or more tethers can be configured to tie or fasten or loop around the (releasable) pins, hook, loop or other anchoring point.

The wing may comprise a wing spar. One or more tethers may be anchored at opposing ends of the wing spar and extend along the wing spar.

The fuselage may comprise a fuselage boom. One or more tethers may be anchored at opposing ends of the fuselage boom and extend along the fuselage boom. A fuselage boom is an elongate, longitudinal, nacelle-like load bearing beam. The fuselage boom forms the longitudinal structure of the aerial vehicle to which the wings and tail assembly are attached, and may extend forward of the wings.

In case a structural failure of the wing occurs during flight of the aerial vehicle, the aerial vehicle can be retained by the wing tether and can assume a shape such that the aerial vehicle descends in a helical rotation motion.

Due to the asymmetric mass distribution that a structural failure can cause during the flight of the aerial vehicle, aerodynamic dumping may create a tilt in the aerial vehicle. The tilt of the aerial vehicle may evolve in a gliding downward motion along a helical path. This may generate aerodynamic force that slows down the aerial vehicle descent, resulting a rotating motion of the aerial vehicle and a steady speed of descent until the aerial vehicle reaches the ground. The rotating motion may be clockwise or counter-clockwise.

### BRIEF DESCRIPTION OF THE DRAWINGS

Embodiments of the invention will now be described with reference to the accompanying drawings, in which:

FIG. 1 shows a perspective view of an exemplary aerial vehicle according to an embodiment of the invention;

FIG. 2 shows a perspective view of a second exemplary aerial vehicle according to an alternative embodiment of the invention;

FIG. 3a shows a tether passing through a tubular structure, and FIG. 3b shows a tether secured on the outside of an elongate structure;

FIGS. 4a, 4b and 4c show alternative arrangements for anchoring ends of tethers;

FIG. 5 is a perspective, partial view of part of an exemplary joint between a wing portion and a fuselage boom for the aerial vehicles of FIGS. 1 and 2;

FIG. 6 shows a schematic view of a tether anchored to a payload component and to a motor component;

FIG. 7 shows a perspective view of the aerial vehicle embodiment of FIG. 1 after structural failure of the wing occurs; and

FIG. 8 shows the aerial vehicle of FIG. 7 in a rotating descent.

### DETAILED DESCRIPTION OF EMBODIMENT(S)

In an embodiment the aerial vehicle is an unmanned aerial vehicle (UAV) 1 as presented in FIG. 1. The UAV 1 has a boom fuselage 7 and wings 6 extending either side of the fuselage boom 7. A nose 15a of the fuselage extends forwards of the wings, opposite a tail or tailplane 15b.

The UAV 1 can be fully autonomous and operated by on-board computers or can be piloted remotely. The UAV 1 can be used in military, humanitarian, scientific or commercial missions, for example, surveillance, search and rescue, weather and pollution monitoring or aerial photography for mapping.

The UAV 1 may be arranged to sustain only light aerodynamic loads, and hence have a particularly lightweight design. For example, the UAV 1 may be configured to withstand aerodynamic or flight induced loads from −1g to 3g. Preferably, the UAV 1 may withstand positive g from 0g to +2g. Beyond the limits of such loading, structural failure may occur at a part of the UAV 1.

A tether T1 passes through the wings 6 and an additional tether T2 passes through the fuselage 7. The tether T1 is anchored at opposing ends of the wings 6 at anchors 18 and 20. The tether T2 passes through the fuselage 7 and is anchored at opposing ends of the fuselage tube at anchors 14 and 16. In case of structural failure at any intermediary part of wings 6 and/or fuselage 7, the tethers T1 and T2 retain the broken parts of the wing 6 and/or fuselage 7 connected to the UAV 1.

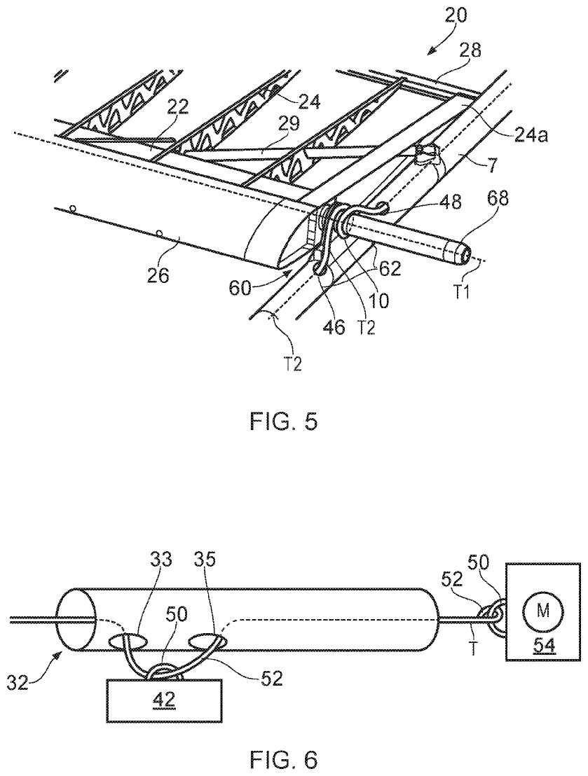

In this embodiment, the tether T2 is arranged to loop around the tether T1 and form a loop 10 as illustrated in more detail in FIG. 5 that shows a cutaway perspective view of the wing-fuselage connection. In case of structural failure the loop 10 enables the wings 6 and the fuselage 7 to remain connected. In alternative embodiments, the tether T1 can be arranged to loop around the tether T2.

The fuselage 7 has a minimal structure, comprising simply a lightweight tube as a ‘boom fuselage’, with the wings 6 and the tailplane 15b attached to the tube. The tube is of carbon fibre construction. In alternative embodiments, the fuselage may be constructed of any lightweight material, for example wood, plastic or fibre reinforced composite, and may be hollow or solid, and of any shape suitable for having wings and tailplane attached. In this embodiment the tether T2 passes through the lightweight tube. In alternative embodiments, a tether run along the outside of the fuselage, which may be hollow or solid, and can be anchored at one or more intermediary locations along the surface of the fuselage.

Each of the wings 6 carry a motor driven propeller 2. Each propeller 2 is powered by an electric motor 11 mounted within the wing structure. The propellers 2 are shaped for high altitude, low speed flight. In an alternative embodiment the propellers may be configured in a pusher configuration arranged at the tail of the UAV.

Each propeller 2 may be powered by rechargeable batteries, or, as shown in this embodiment, the batteries may be recharged during flight via solar energy collecting cells 12. The batteries are clustered as packs 23 held within the wing structure. The tether T1 is anchored at the batteries pack 23 and the electric motors 11 by anchoring fasteners, as illustrated in FIG. 6.

The solar energy collecting cells 12 in this embodiment are located over most of the upper surface of the wings 6. In other embodiments, the solar cells 12 may be located over less of the wing surface or on the tailplane 15b, according to the energy requirements in flight of the particular aerial vehicle being used.

The tailplane 15b has cruciform horizontal and vertical stabilisers 5 and 8 attached to the fuselage 7. The horizontal stabiliser 5 is an all moving elevator. The vertical stabiliser 8 has a non-movable portion 8a and a movable rudder 8b at the trailing portion of the vertical stabiliser 8. Actuators, not shown in the figure, control the movement of the elevator and rudder 8b.

The tether T2 is anchored at opposing ends of the fuselage 7, as will be described in further detail below. The tether T2 passes through the attachment of the horizontal and the vertical stabilisers 5 and 8 to the fuselage 7. In case of structural failure, the stabilisers remain connected to the UAV 1 by the tether T2.

The wings 6 have no movable flight control surfaces. Pitch, yaw and roll control is provided primarily by the vertical and horizontal stabilisers 8 and 5. In an alternative embodiment the vertical stabiliser 8 is an all-moving rudder and the horizontal stabiliser 5 is an all-moving elevator. In another embodiment, a portion of a fixed horizontal stabiliser 5 may have a movable elevator. In such embodiments the tether T2 is anchored at the elevator to ensure that in case of structural failure the elevator remains connected to the UAV 1.

The wings 6 extend in a spanwise direction with a wingspan of between 20 to 60 metres. The wings 6 may be straight or tapered in the outboard direction, and the wings 6 may be horizontal or have a dihedral or an anhedral angle from the point the wing meets the fuselage, or from any point along the wing.

The UAV 1 excluding any payload has a mass of between around 30 kg to 150 kg. The UAV 1 carries a payload, and the total weight of the vehicle is comprised of greater than around 30% payload, preferably greater than around 40% payload and more preferably greater than around 50% payload. Payload can include data acquisition, storage and transmission equipment, and associated power supplies such as batteries 23, for example. The payload of the UAV 1 is carried mainly within the wing structure, but could alternatively be distributed within any part of the UAV 1, depending on size and weight balance requirements. When the payload is carried within the wing structure, the tether T1 is anchored at the payload through anchoring fasteners, as illustrated in the FIG. 6. When the payload is carried within the fuselage structure, the tether T2 is anchored at the payload through an anchoring loop, as illustrated in the FIG. 6.

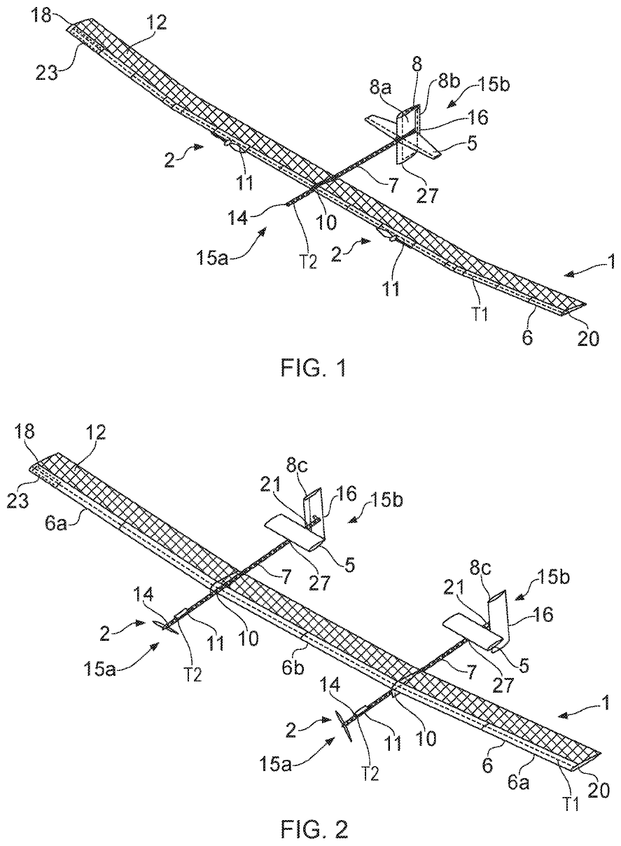

FIG. 2 presents an alternative embodiment of the UAV 1. The UAV 1 presented in FIG. 2 has common features and functional characteristics with the UAV 1 presented in FIG. 1. The main difference between the two embodiments is that the UAV 1 of FIG. 2 has two parallel fuselage booms 7 with propellers 2 and motors 11 arranged at the front end of the respective fuselage booms 7. Other features generally correspond, and like reference numerals identify like features.

The UAV 1 of FIG. 2 has a wing 6 and two boom fuselages 7. The wing 6 is formed of six portions for ease of ground transport and which fit together to form the wing 6. The wing 6 has two central portions 6b spanning between the booms 7, and four outboard portions 6a with two outboard portions 6a extending outwardly from the respective booms 7. The central portions 6b are substantially horizontal. The outboard portions 6a form a dihedral angle with the central portions 6b. In another embodiment, the outboard portions 6a can be substantially horizontal with the central portion 6b. A tether T1 passes through the wing 6 and is anchored at the wing tips 18 and 20 at opposing ends of the wings 6.

The booms 7 are positioned equidistantly on either side of the UAV 1 centreline. Each boom 7 has a nose 15a which extends forwards of the wings 6. At each nose 15a electric motors 11 are mounted for driving each propeller 2 that provides propulsion to the UAV 1 when in operation. A tether T2 passes through each of the respective booms 7 and is anchored at anchors 14 and 16 at opposing ends of the booms 7. Each of the tethers T2 is anchored at the electric motors 11 by an anchor, as shown in FIG. 6. Each of the tethers T2 forms a tether loop 10, as illustrated in FIG. 5, around the tether T1 of the wings 6.

Each boom 7 has a tail 15b which has control surfaces, i.e. vertical stabilisers 8 and horizontal stabilisers 5 to provide longitudinal and/or directional stability and control. A portion of the vertical stabilisers 8, extends below each of the respective booms 7. The horizontal stabiliser is an all moving elevator 5. The vertical stabiliser is an all moving rudder 8c. In an alternative embodiment the horizontal stabiliser 5 and the vertical stabiliser 8 can have a fixed portion and a moving control surface.

Each of the tethers T2 secures the horizontal and the vertical stabilisers 5 and 8 to each boom 7 to ensure that in case of structural failure the stabilisers remain connected to the UAV 1. Each of the tethers T2 secures the horizontal stabiliser 5 through an anchor 27 and the vertical stabilisers 8c through an anchor 21.

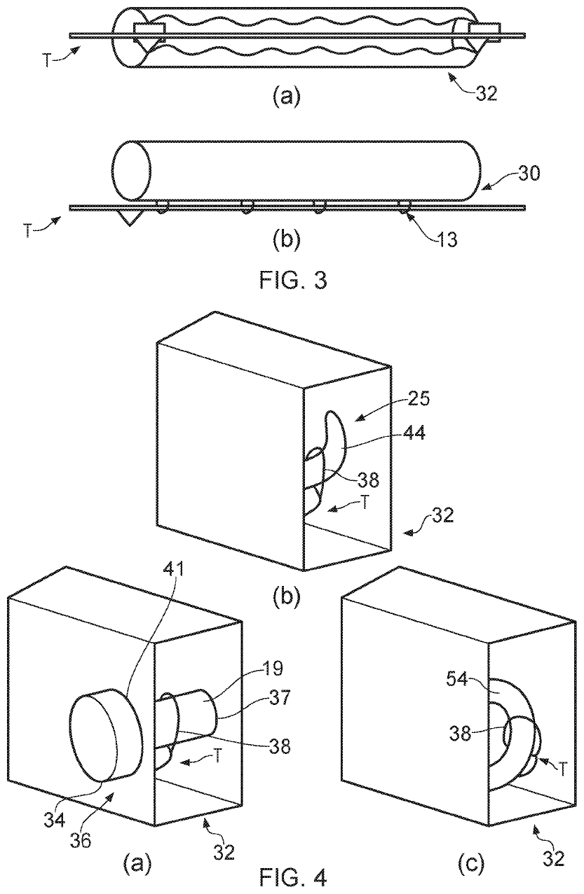

FIG. 3a illustrates schematically a tether T passing through a tubular structure 32. The cut away portion of the tubular structure makes the tether T visible throughout the tubular structure 32. Such a tubular structure arrangement can be part of a spar of the wing 6 and/or the fuselage boom 7.

In each of the embodiments illustrated at FIGS. 1 and 2, tubular structures for each of the tethers T1 and T2 to pass through are present. In alternative embodiments, the fuselage and/or the wing spar may have an elongate structure, which may be solid, as described below.

FIG. 3b is a schematic representation of an elongate structure 30, for example, a part of a solid or hollow tubular wing spar, or a part of a solid or hollow tubular fuselage. The tether T is secured along an outer surface of the elongate structure 30 through retainers or anchors 13.

The retainers or anchors can have different forms, such as a loop, hoop, hook or other anchoring means and are used to secure the tether along the surface of an elongate structure. The tether may run in a channel groove formed along the outer surface of the elongate structure.

FIGS. 4a, 4b and 4c illustrate anchors such as a releasable pin 36, a hook 38 and a loop 54. The anchors secure a tether T at the either end of the wing spar or fuselage boom of the UAV 1.

FIG. 4a shows the releasable pin 36, having a pin head 34 and an elongate pin body 19. The pin body 19 is inserted through apertures 37 and 41 through a wall section of the tubular structure 32, shown having a square section but could have any suitable section. The apertures 37 and 41 have a diameter sized to accept the diameter of the pin body 19. The pin head 34 is positioned against the outer surface of the tubular structure 32, and retained with a pin retainer or, if the pin body has a threaded end, a threaded nut for example. The tether T has an end looped around the elongated body 19 forming a tether loop 38 that keeps the tether T in place. The tether is preferably not in tension.

FIG. 4b shows a hook 25 having curved body 44 extending from an interior wall of the tubular structure 32. The tether T is wrapped around the curved body 44 forming a tether loop 38 to secure the tether T in place. The curved body 44 retains the tether T and ensures it remains in place.

FIG. 4c shows a closed hoop 54 attached at an internal wall of the tubular structure 32. The tether T is wrapped around the hoop forming a tether loop 38 to ensure the tether T is secured in place.

In the case of a solid elongate structure having the tether T arranged along the outside of the elongate structure, the hook 25 or hoop 54 may be formed on the exterior surface of the elongate structure to anchor the tether.

The wings 6 of the UAV 1 presented in FIGS. 1 and 2 each comprise a plurality of aerofoil portions 20. FIG. 5 illustrates a partial perspective view of the aerofoil with the outer wing skin removed for clarity. The aerofoil portion 20 comprises a spanwise extending spar 22, with a plurality of chordwise extending rib sections 24 and a final rib section 24a attached to the spar 22 at intervals along the span. A spanwise extending leading edge arrangement 26 attaches to the spar 22, and a spanwise extending trailing edge arrangement 28 attaches to an end of each rib section 24 at the trailing edge.

A brace 29 extends from the spar 22 to the fuselage 7. The fuselage 7 has a bracket 60 attached at a position on the fuselage 7 that correlates to the required attachment location for the spar 22. The aerofoil portion 20 is thereby positioned on the fuselage 7. In this embodiment, the bracket 60 is attached by straps 62 to the fuselage 7. In alternative embodiments, the bracket may be integrally formed with the fuselage. The bracket forms a lug 64 having a hole through which a connecting arm member or joiner tube 68 passes. The joiner tube 68 has two ends, enabling one aerofoil portion to be connected at each end of the joiner tube 68. Two aerofoil portions are thereby attached, one portion on either side of the fuselage 7.

The wing tether T1 passes through the substantially square tubular spar 22 and spar portion joiner tube 68 and into an adjacent substantially square tubular spar 22 on the other side of the fuselage boom 7 (not shown in FIG. 5).

The fuselage tether T2 passes through the fuselage boom 7 and exits the fuselage 7 through an aperture 46. Then the tether T2 forms the loop 10 around the spar, or more specifically the joiner tube 68, and re-enters the fuselage 7 through another aperture, aperture 48. Since the wing tether T1 passes through the spar portion 22 and joiner tube 68, the loop 10 of the fuselage tether T2 around the wing tether T1 ensures that the wings 6 and the fuselage 7 will remain all connected in case of structural failure, e.g. a detachment of the wing 6 from the fuselage 7.

In an alternative embodiment, the apertures 46 and 48 are positioned at the joiner tube 68 or at the spar 22. In such embodiment the tether T1 exits the joiner tube 68 or the spar 22, forms a loop around the fuselage 7 and re-enters the joiner tube 68 or the spar 22.

FIG. 6 is a schematic representation of a tether T anchored at high mass parts of the UAV 1. Such high mass parts are carried within the wing or the fuselage structure and are mounted on the UAV 1. In FIG. 6 the high mass parts and a payload 42 and a motor 54, but the same principle applies to any and possibly all high mass parts of the UAV 1 which should remain connected even in the event of structural failure.

The tether T passes through the tubular structure 32. Apertures 33 and 35 are formed at the surface of the tubular structure 32 to allow the tether T to exit and re-enter the tubular structure 32. The payload 42 and the motor 54 are positioned close to the tubular structure 32. Each of the payload 42 and motor 54 components has at least one anchor 50 or retainer attached. In this embodiment the anchor 50 is a loop, but any suitable anchoring means may be used for attaching the high mass components to a loop 52 formed in the tether T. Thus, in case of structural failure of a mounting point between the payload 42 and the UAV 1, or between the motor 54 and the UAV 1, the payload 42, motor 54 (or other similarly anchored high mass components) are retained by the tether T.

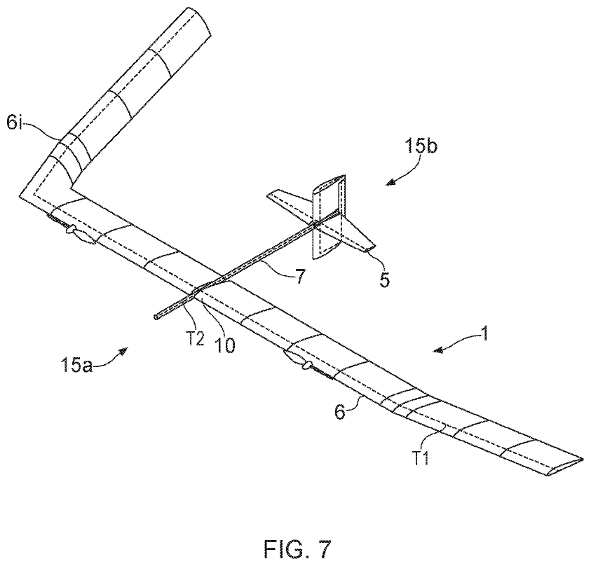

FIG. 7 is a schematic perspective view of the UAV 1 of FIG. 1 during flight. A wing structural failure 6i in the right part of the wing 6 is illustrated. The structural failure 6i can occur, e.g. due to unexpected excessive aerodynamic load or impact due to an external object.

The tether T1 retains the failed wing 6i connected to the UAV 1 and the UAV 1 descends to the ground. In this embodiment the failed wing 6i is shown kinked back due to air flow over the surface of the failed wing 6i.

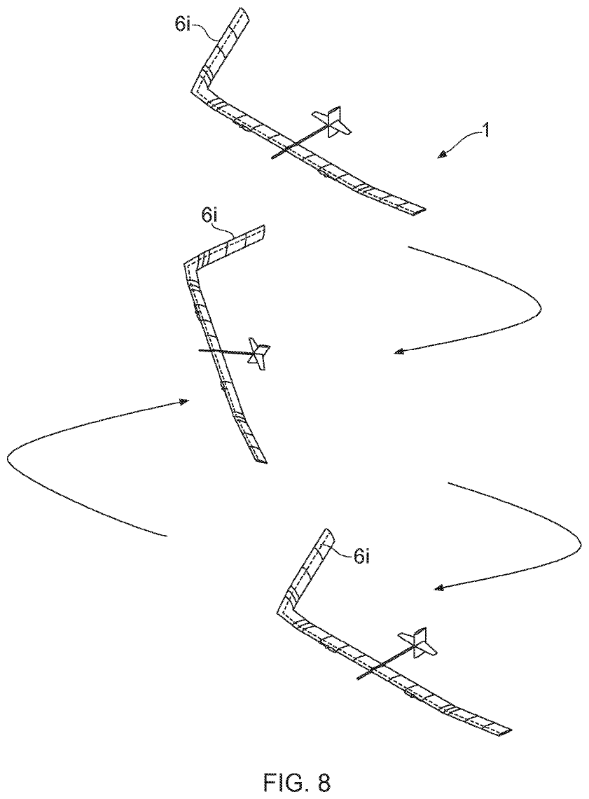

The descent of the UAV 1 is illustrated in FIG. 8. Due to the asymmetric lift distribution created by the failed wing 6i, the UAV 1 descends in a gliding downward motion along a helical path as shown by the arrows. Although only one wing is shown with structural failure, the failure of the wing may cause acceleration of the other wing causing structural failure of the other wing as well. This rotating motion of the UAV 1 results in a slow steady descent until the UAV 1 reaches the ground. The rotating motion can be clockwise or counter-clockwise. The slow speed of descent may reduce the likelihood of further break-up of the UAV during the descent, and may help to ensure that impact with the ground is at a slow forward and vertical speed. Depending on the type and location of the failure, the pilot or auto-pilot may retain at least some directional control over the aircraft so as to reach the ground in an uninhabited area, particularly if the failure is not a wing failure.

Depending on where the structural failure(s) occur in the UAV the exact mode of descent and level of directional control may change, but by retaining significant parts of the UAV 1 together the level of control, and the speed and mode of descent, can be better controlled to bring the UAV back to the ground.

Although the invention has been described above with reference to one or more preferred embodiments, it will be appreciated that various changes or modifications may be made without departing from the scope of the invention as defined in the appended claims.

1-13. (canceled)

14. An aerial vehicle comprising a wing, a fuselage and at least one tether anchored at opposing ends of the wing and/or the fuselage, wherein the at least one tether is arranged to prevent one or more parts of the aerial vehicle from separating from the remainder of the aerial vehicle in the event of structural failure of the aerial vehicle.

15. An aerial vehicle according to claim 14, including a plurality of the tethers, wherein one of the tethers is looped around another of the tethers so as to couple the tethers.

16. An aerial vehicle according to claim 14, wherein the wing and/or the fuselage includes a tubular structure and the at least one tether passes through the tubular structure.

17. An aerial vehicle according to claim 16, wherein the tubular structure includes at least one aperture configured to permit the tether to enter or exit the tubular structure.

18. An aerial vehicle according to claim 14, wherein the wing and/or the fuselage includes an elongate structure and the at least one tether is secured to the elongate structure at one or more intermediary locations between the opposing ends of the wing and/or the fuselage.

19. An aerial vehicle according to claim 14, wherein the at least one tether has a relatively high tensile strength and is more flexible than the wing and/or the fuselage.

20. An aerial vehicle according to claim 14, further comprising at least one component of significant mass as a proportion of the aerial vehicle as a whole, wherein the at least one tether is anchored to the at least one component of significant mass.

21. An aerial vehicle according to claim 20, wherein the at least one component of significant mass includes one or more of: a flight control surface, a payload, a motor, or a propeller.

22. An aerial vehicle according to claim 14, wherein the at least one tether is configured to be anchored by passing the tether around one or more of: a pin, a hook, or a loop.

23. An aerial vehicle according to claim 14, wherein the wing comprises a wing spar, and the at least one tether is anchored at opposing ends of the wing spar and extends along the wing spar.

24. An aerial vehicle according to claim 14, wherein the fuselage comprises a fuselage boom, and the at least one tether is anchored at opposing ends of the fuselage boom and extends along the fuselage boom.

25. An aerial vehicle according to claim 14, having at least one tether anchored at opposing ends of the wing, and configured such that in the event of structural failure of the wing, the aerial vehicle retained by the tether assumes a shape such that the aerial vehicle descends in a helical rotating motion.

26. An aerial vehicle according to claim 14, operable to fly in the stratosphere, preferably at altitudes above 18 kilometres.

27. An aerial vehicle according to claim 14, wherein the aerial vehicle is unmanned.

28. A method of assembling an aerial vehicle comprising a wing and a fuselage, the method comprising:
providing at least one tether; and
anchoring the tether at opposing ends of the wing and/or the fuselage, wherein the at least one tether is arranged to prevent one or more parts of the aerial vehicle from separating from the remainder of the aerial vehicle in the event of structural failure of the aerial vehicle.
